(19) United States
(12) Patent Application Publication
(10) Pub. No.: US 2009/0114123 A1
(43) Pub. Date: May 7, 2009

(54) Thin-layer lignocellulose composites having increased resistance to moisture and methods of making the same

(75) Inventors: Randy Clark, Klamath Falls, OR (US); Kenneth D. Kiest, Klamath Falls, OR (US)

Correspondence Address: NELSON MULLINS RILEY & SCARBOROUGH, LLP, 1320 MAIN STREET, 17TH FLOOR, COLUMBIA, SC, 29201, US

(73) Assignee: JELD-WEN, inc., Klamath Falls, OR (US)

(21) Appl. No.: 11/983,090

(22) Filed: Nov. 7, 2007

(51) Int. Cl. C08L 97/02

(52) U.S. Cl. 106/164.01

(57) ABSTRACT

A method to produce a thin-layer lignocellulosic composite having increased resistance to moisture-induced shrinking or swelling is provided. The method includes forming a lignocellulosic composite mixture including at least one type of lignocellulosic fiber having a predetermined moisture content of at least about 4 wt %, at least about 1 wt % of an organic isocyanate resin, at least about 0.1 wt % of a tackifier, and at least about 0.1 wt % release agent, wherein the mixture is substantially free of added wax. The method further includes pre-pressing the mixture into a loose formed mat and pressing the mat between two dies at an elevated temperature and pressure and/or a sufficient time to further reduce the thickness of the mat to form a thin-layer composite of predetermined thickness, and to allow the isocyanate resin to interact with the lignocellulosic fiber such that the resultant thin-layer composite has a predetermined resistance to moisture.

### BACKGROUND OF THE INVENTION

The present invention relates to the manufacture of thin-layer lignocellulosic composites, such as wood-based doorskins. More particularly, the present invention relates to thin-layer wood composites that include an isocyanate based-resin and thus, exhibit significantly less swelling and/or shrinking upon exposure to the environment.

A significant problem in the manufacture of wood-based composite products that are exposed to the exterior and extreme interior environments is that upon exposure to variations in temperature and moisture, the wood can lose water and shrink, or gain water and swell. This tendency to shrink and/or swell can significantly limit the useful lifetime of most exterior wood products, such as wooden doors, often necessitating replacement after only a few years. The problem is particularly prevalent in areas of high moisture (e.g., Hawaii) or in climates that are extremely hot or dry (e.g., Arizona). Shrinking and swelling can also be a problem when the wood is exposed to a wet environment during construction, or upon exposure to the dry heat used indoors in the winter.

A possible solution to the problem of moisture gain and loss in wood exposed to the elements includes covering the wood with paint and/or other coatings that act as a barrier to moisture. Still, such coatings tend to wear off with time, leaving the wood susceptible to the environment.

Rather than treating the unit at the site of installation, it may be preferable to manufacture products that exhibit increased resistance to moisture gain and loss. For example, increasing the amounts of resin content or decreasing the amount of wood fiber used in a door can increase resistance to water gain and water loss. Such modifications, however, can be associated with significantly increased production challenges. Other options include the use of metal or fiberglass doors, but such doors are not always as aesthetically pleasing as wood doors and may have other performance problems associated with the use of these materials.

Alternatively, doors, and other structural units, may be constructed with a wood-composite water-resistant layer. For example, doors may be constructed from a thin-layer wood composite known as a doorskin. Generally, doorskins are molded as thin layers and secured to an underlying door frame to thereby provide a water-resistant outer surface. Doorskins may be made by mixing wood fiber, wax, and a resin binder, and then pressing the mixture under conditions of elevated temperature and pressure to form a thin-layer wood composite that may then be bonded to the underlying door frame. Wood composite doorskins are traditionally formed by pressing wood fragments in the presence of a binder at temperatures exceeding 275° F. (135° C.). The resin binder used in the doorskin may be a formaldehyde-based resin, an isocyanate-based resin, or other thermoplastic or thermoset resins. Formaldehyde-based resins typically used to make wood composite products include phenol-formaldehyde, urea-formaldehyde, or melamine-formaldehyde resins. Phenol-formaldehyde resins require a high temperature cure and are sensitive to the amount of water in the wood since excess water can inhibit the high temperature cure. Urea and melamine-formaldehyde resins do not require as high of a temperature cure, but traditionally do not provide comparable water-resistance (at the same resin content) in the doorskin product.

As compared to doorskins made using phenol-formaldehyde resins, doorskins that utilize high-temperature pressed isocyanate resin binder display increased surface strength. These doorskins, however, exhibit decreased porosity to adhesives and thus, do not bond well to the underlying doorframe. Also, isocyanate-bonded wood composites made using currently available methods and compositions do not consistently exhibit sufficient resistance to environmentally-induced swelling and/or shrinking to be commercially useful.

### SUMMARY OF THE INVENTION

In one aspect, the invention is a method to produce a thin-layer lignocellulosic composite having increased resistance to moisture-induced shrinking or swelling. The method includes forming a lignocellulosic composite mixture including at least one type of lignocellulosic fiber having a predetermined moisture content of at least about 4 wt %, at least about 1 wt % of an organic isocyanate resin, at least about 0.1 wt % of a tackifier, and at least about 0.1 wt % release agent, wherein the mixture is substantially free of added wax. The method further includes pre-pressing the mixture into a loose formed mat and pressing the mat between two dies at an elevated temperature and pressure and/or a sufficient time to further reduce the thickness of the mat to form a thin-layer composite of predetermined thickness, and to allow the isocyanate resin to interact with the lignocellulosic fiber such that the resultant thin-layer composite has a predetermined resistance to moisture.

In another aspect, the invention is a thin-layer lignocellulosic composite. The composite includes a mixture of no more than about 99 wt % of at least one lignocellulosic fiber having a predetermined moisture content of at least about 4 wt %, at least about 1 wt % of an organic isocyanate resin, a release agent, and a tackifier, wherein the mixture is substantially free of added wax. The mixture is pressed between two dies at an elevated temperature and pressure and for a sufficient time to form a thin-layer composite of predetermined thickness, and to allow the isocyanate resin to interact with the lignocellulosic fiber such that the resultant thin-layer composite has a predetermined resistance to moisture.

It is to be understood that the invention is not limited in its application to the specific details as set forth in the following description, figures and claims. The invention is capable of other embodiments and of being practiced or carried out in various ways.

### BRIEF DESCRIPTION OF THE FIGURES

FIG. 1 illustrates an embodiment of a method that may be used to make a thin-layer wood composite doorskin.

FIG. 2 illustrates an embodiment of a method used to make water-resistant thin-layer wood composites in accordance with an embodiment of the present invention where panel (a) shows mixing of the lignocellulosic fiber and resin; panel (b) shows forming the composite into a loose formed mat; panel (c) shows spraying the loose formed mat with release agent; panel (d) shows pressing the mat between two dies; and panel (e) shows the resultant thin-layered composite product.

### DETAILED DESCRIPTION OF ILLUSTRATIVE EMBODIMENTS

The present invention provides for the manufacture of thin-layer lignocellulosic composites that include levels of isocyanate-based resins that inhibit the composite from shrinking and swelling after exposure to the elements. The invention may be applied to various types of lignocellulosic thin-layer composites to generate structural units that may be exposed to weathering by heat, moisture, air, and the like. In an embodiment, the present invention describes a method to make wood-based doorskins that are resistant to shrinking and swelling.

Thus, in an embodiment, the present invention comprises a method to produce a thin-layer lignocellulosic composite having increased resistance to moisture-induced shrinking and swelling comprising the steps of: (a) forming a lignocellulosic composite mixture comprising at least one type of lignocellulosic fiber comprising a predefined moisture content of at least about 1 wt % and at least 5 wt % of an organic isocyanate resin at least about 0.1 wt % tackifier, and at least about 0.1 wt % release agent, wherein the mixture is substantially free of added wax; (b) prepressing the mixture into a loose formed mat; and (c) pressing the mat between two dies at an elevated temperature and pressure and for a sufficient time to further reduce the thickness of the mat to form a thin-layer composite of predetermined thickness, and to allow the isocyanate resin to interact with the lignocellulosic fiber such that the resultant thin-layer composite has a predetermined resistance to moisture.

The present invention also comprises thin-layer lignocellulosic composites made by the methods of the invention. Thus, in another embodiment, the present invention also comprises a thin-layer lignocellulosic composite comprising a mixture of no more than about 98 wt % of at least one type of lignocellulosic fiber, wherein the fiber has a predetermined moisture content of at least about 4 wt %, and at least 5 wt % of an organic isocyanate resin, at least about 0.1 wt % tackifier, and at least about 0.1 wt % release agent, wherein the release agent may include a wax and the mixture is substantially free of added wax, and wherein the mixture is pressed between two dies at an elevated temperature and pressure and for a sufficient time to form a thin-layer composite of predetermined thickness, and to allow the isocyanate resin to interact with the lignocellulosic fiber such that the resultant thin-layer composite has a predetermined resistance to moisture.

The lignocellulosic fiber comprises a material containing both cellulose and lignin. Suitable lignocellulosic materials may include wood particles, wood fibers, straw, hemp, sisal, cotton stalk, wheat, bamboo, jute, salt water reeds, palm fronds, flax, groundnut shells, hard woods, or soft woods, as well as fiberboards such as high density fiberboard, medium density fiberboard, oriented strand board and particle board. In an embodiment, the lignocellulosic fiber is refined. As used herein, refined fiber comprises wood fibers and fiber bundles that have been reduced in size, from other forms of wood such as chips and shavings. The refined wood fiber is normally produced by softening the larger wood particles with steam and pressure and then mechanically grinding the wood in a refiner to produce the desired fiber size. In an embodiment, the lignocellulosic fiber of the thin-layer composites of the present invention comprise wood fiber.

As used herein, a thin-layer composite comprises a flat, planar structure that is significantly longer and wider than it is thick. Examples of thin-layer lignocellulosic composites include wood-based doorskins that are used to cover the frame of a door to provide the outer surface of the door. Such doorskins may be only about 1 to 5 mm thick, but may have a surface area of about 20 square feet (1.86 square meters) or more. Other thin-layer lignocellulosic products may include Medium Density Fiberboard (MDF), hardboard, particleboard, Oriented Strand Board (OSB) and other panel products made with wood. These products are normally 3 to 20 mm in thickness.

In an embodiment, the lignocellulosic composite is substantially free of added wax. As used herein, the term “added wax” is intended to include wax added to the mixture as a distinct component. Similarly, as used herein, “substantially free of added wax” is intended to include composites having no wax, as well as composites having a negligible amount of wax at concentrations that would not materially affect the composites, where the wax is a part of a different component of the mixture, for example the tackifier and/or release agent. For example, a composite having less than about 0.4% wax may be encompassed by the term “substantially free of added wax.” In some embodiments, the composite is free of added wax. In some embodiments, various components, such as, for example, the tackifier or the release agent, may include certain amounts of wax. Embodiments in which the tackifier and/or the release agent include wax are considered to be substantially free of added wax.

The lignocellulosic mixture of the present invention further includes at last one tackifier. As used herein, the term “tackifier” is intended to include those compounds typically used in the adhesive industry to impart and/or improve the stickiness of adhesives. In the present invention, a tackifier may be blended into the mixture prior to pressing the mixture to form the present thin-layer lignocellulosic composites.

Without being bound by theory, it is believed that the tackifier enhances the interaction of the lignocellulosic fibers and the isocyanate resins, while enabling release of the composites from the dies after pressing.

Tackifiers contemplated as useful in the present invention include those tackifiers known in the adhesive industry. Suitable tackifiers include one or more tackifiers selected from rosins, lignins, hydrogenated rosins, hydrocarbons, hydrogenated hydrocarbons, pure monomers, hydrogenated pure monomers, terpene resins, and water-based dispersions of each of these. Lignosulfates, polyvinylalcohol resins, and acrylic resins are also contemplated as useful tackifiers in accordance with the present invention.

Examples of rosins and hydrogenated rosins (either fully or partially hydrogenated) include, but are not limited to, gum rosins, wood rosins, and tall oil rosins. Examples of hydrocarbons and hydrogenated hydrocarbons (either fully or partially hydrogenated) include, but are not limited to, C5 aliphatic hydrocarbon resins, such as trans-1,3-pentadiene, cis-1,3-pentadiene, 2-methyl-2-butene, dicyclopentadiene, cyclopentadiene, and cyclopentene; C9 aromatic hydrocarbons, such as vinyl toluenes, dicyclopentadiene, indene, methylstyrene, styrene, and methylindenes; and C5/C9 aliphatic/aromatic hydrocarbons, such as any combination of C5 aliphatic hydrocarbons and C9 aromatic hydrocarbons. Examples of terpene resins include, but are not limited to, thermoplastic terperene phenolic resins, terpene phenolic resins, polyterpene resins, styrenated terpene resins, and beta-pinene.

In the present invention, tackifiers may be added to the mixture at a concentration of between about 0.1% and about 5 wt %, in other embodiments between about 1% to about 2 wt %, and in some embodiments at a concentration of about 1.5 wt %.

As described herein, the lignocellulosic mixtures of the present invention are pressed into thin-layers using flat or molded dies at conditions of elevated temperature and pressure. In an embodiment, the mixture is initially formed into a loose formed mat, and the mat is placed in the die press. Because the composite includes amounts of resin that are sufficient to increase the water resistance of the composite mixture, the composite may stick to the surface of the dies that are used to press the mat into the resultant thin layer composite. Thus, in an embodiment, the method includes steps to reduce sticking of the thin-layer composite to the dies.

In an embodiment, the method includes exposing the lignocellulosic composite mixture to a release agent prior to pressing the composite between the dies. In an embodiment, the release agent comprises an aqueous emulsion of surfactants and polymers. In one embodiment, the release agent is not a wax. For example, the release agent may comprise compounds used in the doorskin manufacturing industry such as, but not limited to, PAT®7299/D2 or PAT®1667 (Wurtz GmbH & Co., Germany).

The release agent may be added directly to the lignocellulosic composite mixture as an internal release agent prior to pre-pressing the mixture into a loose formed mat. Alternatively and/or additionally, the release agent may be sprayed on the surface of the mat before the mat is pressed into a thin layer.

Where the release agent is added directly to the mixture as an internal release agent, the amount of release agent added may range from about 0.1 to about 4 wt % of the mixture, in other embodiments between about 0.25 wt % to about 3 wt %, in other embodiments between about 0.5 wt % to about 1.5 wt %. In one embodiment, about 0.8 wt % release agent is used.

Where the release agent is sprayed onto a surface of the mat, the amount of release agent sprayed on to the mat surface may comprise from about 0.1 to about 8.0 grams solids per square foot (about 1.1 to about 86.1 grams per square meter) of mat surface. In another embodiment, the amount of release agent sprayed on the mat surface may comprise about 4 grams solids per square foot (about 43 grams per square meter) of mat surface. The release agent may be applied as an aqueous solution. In an embodiment, an aqueous solution of about 25% release agent is applied to the mat surface. When the thin-layer composite comprises a doorskin, the release agent may be applied to the surface of the mat that corresponds to the surface that will become the outer surface of the doorskin.

The selected release agent(s) should be release agents that do not interfere with subsequent processing of the resultant thin-layer composites, for example, priming and/or gluing of the final product. Release agents will typically migrate to the surface of a composite during pressing and remain at or on the surface. Some release agents, such as fatty acid release agents, are known to migrate and then interfere with subsequent processing of the composite. Release agents contemplated as useful in the present invention should include those that would not significantly interfere with subsequent processing.

In an embodiment, the thin-layered lignocellulosic composite is colored. For example, in one embodiment, the release agent may comprise a pigment. In this way, an even coloring is applied to the thin-layered lignocellulosic composite. In some embodiments, a tinted release agent would facilitate subsequent priming or painting of the door.

Thus, the thin-layer lignocellulosic composites of the present invention may comprise wood fibers as well as a tackifier and/or a release agent. For example, in an embodiment, the present invention comprises a wood composite comprising a mixture of: (i) no more than 98 wt % of a wood fiber, wherein the wood fiber has a predetermined moisture content of at least about 4%; (ii) at least about 1 wt % of an organic isocyanate resin; (iii) at least about 0.1 wt % of a tackifier; and (iv) optionally, at least about 0.1% internal release agent by weight and/or at least about 0.1 grams release agent per square foot (about 1.1 grams per square meter) on the surface of the composite.

Other methods may be used to reduce sticking of the lignocellulosic composite to the dies used for making the resultant thin-layer composite. Thus, in another embodiment, at least one surface of the die used to press the mat is exposed to an anti-bonding agent. In an embodiment, exposing the die to an anti-bonding agent may comprise coating at least one of the dies used to press the mat with an anti-bonding agent. In an embodiment, coating the die may comprise baking the anti-bonding agent onto the die surface.

In an embodiment, the release agent is not the same as an anti-bonding agent. The release agent comprises a compound that will not interfere with subsequent processing of the resulting thin-layer composite. In contrast, the anti-bonding agent may comprise compositions known in the art of pressing wood composites as being effective in preventing sticking to the pressing dies, but that may be problematic if included as part of the composite.

For example, in an embodiment, the anti-bonding agent used to coat the die surface can be one or more of silane, silicone, siloxane, fatty acids, and polycarboxyl compounds. Thus, the anti-bonding agent used to coat the die surface may comprise anti-bonding agents known in the art of die pressing such as, but not limited to, CrystalCoat MP-3 13 and Silvue Coating (SDC Coatings, Anaheim, Calif.), Iso-Strip-23 Release Coating (ICI Polyurethanes, West Deptford, N.J.), aminoethylaminopropyltrimethoxysilane (Dow Corning Corporation), or the like.

For thin-layer doorskins, the die that is coated with the anti-bonding agent may correspond to the die used to press the outside surface of the doorskin. Alternatively, both dies may be coated with an anti-bonding agent. In an embodiment, the amount of anti-bonding agent used to coat the die surface may range in thickness from about 0.0005 to about 0.010 inches (i.e., about 0.0127 mm to about 0.254 mm). Thus, in one embodiment, the amount of anti-bonding agent used to coat the die surface comprises about 0.003 inches (i.e., about 0.0762 mm).

In an embodiment, coating the die comprises baking the anti-bonding agent onto the die surface. For example, in one embodiment, the step of baking the anti-bonding agent onto the die surface may comprise the steps of: (i) cleaning the die surface substantially free of dirt, dust and grease; (ii) spraying from about 0.0005 to about 0.010 inches (about 0.5 to about 10 mils or about 0.0127 to about 0.254 mm) of a 50% solution of the anti-bonding agent onto the die; and (iii) baking the die at greater than 300° F. (149° C.) for about 1 to 4 hours.

In an embodiment, the step of exposing the pre-pressed mat to at least one release agent and/or anti-bonding agent may comprise adding an internal release agent and/or spraying one side of the mat with a release agent and also coating at least one die surface with an anti-bonding agent. In this embodiment, the side of the mat coated with the release agent may be the surface opposite to the surface of the mat exposed to the coated die. For example, in an embodiment, the present invention comprises a method to produce a thin-layer wood composite having increased water resistance comprising the steps of (a) forming a mixture comprising: (i) a refined wood fiber comprising a predefined moisture content of at least about 4%; (ii) a tackifier; (iii) at least about 1 wt % of an organic isocyanate resin; and (iv) a release agent; (b) pre-pressing the mixture into a loose formed mat; (c) optionally, spraying one surface of the mat with a release agent; and (d) pressing the mat between two dies at an elevated temperature and pressure and for a sufficient time to further reduce the thickness of the mat to form a thin-layer composite of predetermined thickness, and to allow the isocyanate resin to interact with the wood fibers such that the doorskin has a predetermined resistance to moisture, wherein at least one of the die surfaces has been coated with an anti-bonding agent.

The thin-layered lignocelluiosic composites of the present invention may comprise a range of fiber compositions. Thus, in an embodiment, the lignocellulosic composite mixture comprises about 80% to about 98 wt % fiber.

The thin-layered wood composites of the present invention may comprise lignocellulosic fiber comprising a range of moisture levels. In an embodiment, the method does not require dehydrating the lignocellulosic fiber prior to treatment with the resin. Thus, in an embodiment, the lignocellulosic fiber comprises from about 4% to about 15% moisture content by weight. In another embodiment, the lignocellulosic fiber may comprise from about 8% to about 13% moisture by weight. In another embodiment, the lignocellulosic fiber may comprise about 10% moisture by weight.

The organic isocyanate resin used may be aliphatic, cycloaliphatic, or aromatic, or a combination thereof. Monomeric, oligomeric, and polymeric isocyanates are contemplated as useful in the present invention. In an embodiment, the isocyanate may comprise diphenylmethane diisocyanate (MDI) or toluene diisocyanate (TDI) such as Lupranate®M20FB Isocyanate (BASF Corporation, Wyandotte, Mich.). For example, in an embodiment, the isocyanate comprises diphenylmethane-4,4′-diisocyanate. Or, in an embodiment, the isocyanate is selected from the group consisting of toluene-2,4-diisocyanate; toluene-2,6-diisocyanate;is ophorone diisocyanate; diphenylmethane-4,4′-diisocyanate; 3,3′-dimethyldiphenylmethane-4,4′-diisocyanatem m-phenylene diisocyanate; p-phenylene diisocyanate; chlorophenylene diisocyanate; toluene-2,4,6-triisocyanate; 4,4′,4″-triphenylmethane triisocyanate; diphenyl ether 2,4,4′-triisocyanate; hexamethylene-1,6-diisocyanate; tetramethylene-1,4-diisocyanate, cyclohexane-1,4-diisocyanate; naphthalene-1,5-diisocyanate; 1-methoxyphenyl-2,4-diisocyanate4; ,4′-biphenylene diisocyanate; 3,3′-dimethoxy-4,4′-biphenyl iisocyanate; 3,3′-dimethyl-4,4′-biphenyl diisocyanate; 4,4′-dimethyldiphenylmethane-2,2′,5,5′-teaisocyanate3; ,3′-dichlorophenyl-4,4′-diisocyanate; 2,2′,5,5′-tetrachlorodiphenyl-4,4′-diisocyanate; trimethylhexamethylene diisocyanate; m-xylene diisocyanate; polymethylene polyphenylisocyanates; and mixtures thereof.

A range of isocyanate resin levels may be used to make the thin-layer composites of the present invention. Thus, in an embodiment, the mixture used to form the composite may comprise from about 1% to about 5 wt % resin solids, in some embodiments about 2% to about 4 wt %. In another embodiment, the mixture may comprise about 3 wt % resin solids.

The conditions used to form the thin-layer composite include compressing the mixture at elevated temperature and pressure for sufficient time to allow the isocyanate resin to interact with the wood fibers such that the resultant thin-layer composite has a predetermined resistance to moisture. The exact conditions used will depend upon the equipment used, the exterior environment (e.g., temperature, elevation), the manufacturing schedule, the cost of input resources (e.g., starting materials, electric power), and the like. Also, varying the temperature may allow for changes to be made in the pressure used or the time of pressing; similarly, changes in pressure may require adjustment of the time and/or temperature used for pressing the thin-layer composites of the present invention.

A range of temperatures may be used to promote interaction of the isocyanate resin with the lignocellulosic fibers in the mixture. In an embodiment, the temperature used to press the mixture (or preformed mat) into a thin-layer composite may range from about 250° F. (121° C.) to about 400° F. (204° C.). In another embodiment, the temperature used to press the mixture (or preformed mat) into a thin-layer composite may range from about 280° F. (138° C.) to about 350° F. (177° C.). Or, a temperature that is in the range of from about 310° F. (154° C.) to about 330° F. (166° C.) may be used.

Similarly, the levels of the pressure applied during the pressing of the thin-layer composite may vary depending on a variety of factors, such as the nature of the thin-layer composite that is being formed, the equipment being used, environmental conditions, production capabilities, and the like. Thus, in an embodiment, the pressure during the pressing step may range from about 2500 psi (about 176 kg/cm²) to about 150 psi (about 10.5 kg/cm²). In another embodiment, the pressure may be applied in a step-wise manner. In another embodiment, the pressure during the pressing step ranges from about 1200 psi (about 84.3 kg/cm²) for about 5 to 20 seconds followed by 500 psi (about 35.16 kg/cm²) for 20 to 80 seconds. For example, in one embodiment, the pressure during the pressure step ranges from about 1200 psi (about 84.3 kg/cm²) for about 10 seconds to about 500 psi (about 35.16 kg/cm²) for about 50 seconds.

The thin-layer lignocellulosic composites of the present invention have increased resistance to moisture-induced shrinkage and swelling. As used herein, increased resistance to moisture comprises reduced shrinking and/or swelling of the thin-layer composite when the composite is exposed to conditions of low and high moisture, respectively, as compared to thin lignocellulosic composites made by other methods, or using non-isocyanate resins. The present thin-layer lignocellulosic composites have a moisture content after press of between about 4% and about 8 wt %, in some embodiments between 5% and about 7 wt %.

Thus, in an embodiment, when thin-layer composites of the present invention are exposed to an atmosphere where the moisture level is low, the composite of the present invention exhibits less shrinkage than thin-layer composites made with other resins. Also, in an embodiment, when thin-layer composites of the present invention are exposed to an atmosphere where the moisture level is high, the composite of the present invention exhibits less swelling than thin-layer composites made with other resins.

For example, in an embodiment, the thin-layer composite comprises up to 25% less linear expansion and thickness swelling after being immersed for 24 hours in 70° F. (21° C.) water than a thin-layer composite comprising comparable levels of an alternate resin, either isocyanate resins or non-isocyanate resins. Also in an embodiment, the predetermined resistance to moisture comprises a thickness swelling of less than 15% after being immersed for 24 hours in water at 70° F. (21° C.).

Also in an embodiment, doorskins made by the methods of the present invention are significantly less dense than doorskins made using traditional formaldehyde-based resins. Thus, in an embodiment, the thin-layer lignocellulosic composites of the present invention comprise a density of between about 48 pounds per cubic foot (about 769.0 kg/m³) and about 62 pounds per cubic foot (about 993.4 kg/m³), in some embodiments less than about 60 pounds per cubic foot (about 962 kg/m³). In another embodiment, the thin-layer lignocellulosic composites of the present invention may comprise a density of less than 55 pounds per cubic foot (about 881.5 kg/m³).

### Preparation of Thin-Layer Wood Composites Having Increased Water Resistance

Several methods have been described herein to produce wood composites that exhibit increased resistance to moisture uptake and loss. It is believed that swelling and/or shrinking of wood is, at least partially, the result of water reacting with hydroxyl groups present in cellulose and hemicellulose. Thus, high moisture levels increase the amount of water bound to the wood fiber. Alternatively, in low humidity, water is lost from the wood fibers.

An aspect of the present invention is concerned with methods to employ low concentrations of isocyanate resins to improve the moisture-resistance of thin-layer lignocellulosic composites, such as, but not limited to, wood doorskins. Isocyanate resins such as diphenylmethane-4,4′-diisocyanate (MDI) and toluene diisocyanate (TDI) resin are highly effective in modifying the reactive groups present on cellulose fibers to thereby prevent the fibers from reacting with water. It is believed that the isocyanate forms a chemical bond between the hydroxyl groups of the wood cellulose, thus forming a urethane linkage.

In the present invention, a thin-layer wood composite that is resistant to water is provided with resin contents of between about 1% and about 5% and in some embodiments at levels between about 2% and about 4%. Doorskins are generally on the order of 1 to 5 mm in thickness, with a total surface area of 20 square feet (i.e., 1.86 square meters). When such thin-layer wood composites made with isocyanate resin are prepared using conventional pressing methods, the high resin levels cause the wood composite to stick to the pressing die used to prepare the doorskin after only a few pressing cycles.

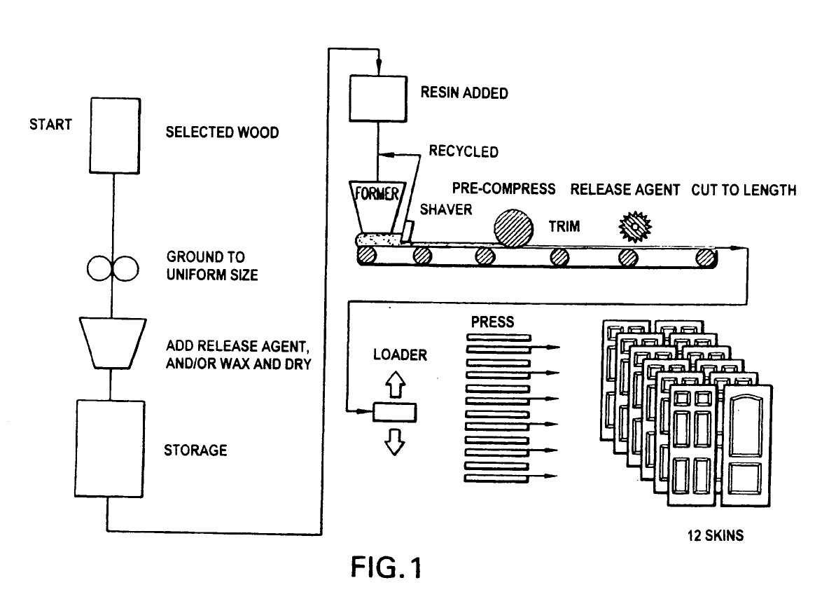

FIG. 1 shows an overview of a general method used to prepare doorskins. Generally, a selected wood starting material is ground to prepare fibers of a uniform size and the appropriate amount of wax added. At this point the preparation may be stored until further processing. The fiber/tackifier blend is then mixed with an appropriate binder resin (e.g., using atomization), until a uniform mixture is formed. It is also common to add the resin to the fiber prior to storage of the fiber.

The mixture may then be formed into a loose formed mat which is pre-shaped using a shave-off roller and pre-compressed to a density of about 6-8 pounds per cubic foot. After further trimming to the correct size and shape, the pre-pressed mat is introduced into a platen press, and compressed between two dies under conditions of increased temperature and pressure. For example, standard pressing conditions may comprise pressing at 320° F. at 1200 psi for 10 seconds followed by 50 seconds at 500 psi (i.e., about 160° C. at 84.3 kg/cm² for 10 seconds followed by 50 seconds at 35.2 kg/cm²). Generally, a recessed (female) die is used to produce the inner surface of the doorskin, and a male die shaped as the mirror image of the female die is used to produce the outside surface of the skin. Also, the die which is forming the side of the doorskin that will be the outer surface may include an impression to create a wood grain pattern or texture. After cooling, the resulting doorskin is mounted onto a doorframe using a standard adhesive and employing mounting methods standard in the art.

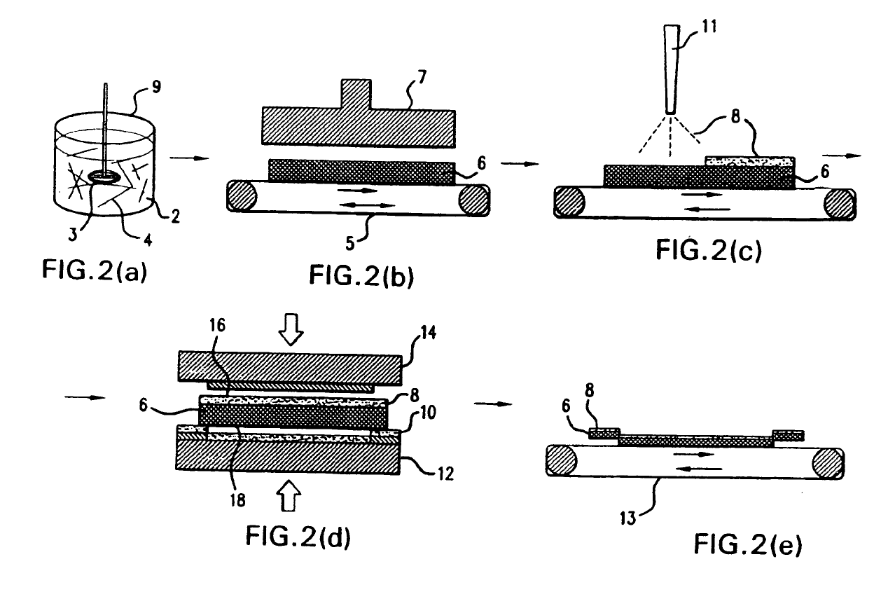

In an embodiment (FIG. 2), the present invention describes a method for making a thin-layer wood composite having increased water resistance comprising forming a wood composite mixture 2 comprising: (i) a refined wood fiber 4 having a predefined moisture content of about 4% to about 15%; (ii) about 0.1% to about 5.0% tackifier; (iii) between about 1.0% and about 5 wt % of an organic isocyanate resin; and (iv) optionally, at least about 1 wt % of an internal release agent (FIG. 2(a)). The mixture may be prepared in bulk using standard blowline blending of the resin and fibers. Or, blenders 9 having a means for mixing 3 such as a paddle or the like, may be used.

Next, the wood composite mixture may be formed into a loose formed mat in a forming box. The mat is then pre-shaped using a shave-off roller (not shown in FIG. 2) and precompressed using a roller or some other type of press 7 (FIG. 2(b)). The specific density of the mat may vary depending on the nature of the wood composite being formed, but generally, the mat is formed to have a density of about 6 to 8 pounds per cubic foot (i.e., 96.2-128.1 kg per cubic meter). After further trimming of the mat to the correct size and shape, at least one surface of the mat may be exposed to additional release agent 8 by spraying the release agent onto the surface of the mat 6 using a spray nozzle 11 (FIG. 2(c)). Also, shown in FIG. 2 are conveyors 5 and 13 as a means for transferring the wood composite from one station to another. It is understood that other means of supporting or transferring the thin-layer wood composite from one station to another, or supporting the composite during the processing steps may be used.

The mat 6 may then be placed between a male die 14 and a female die 12, and pressed at an elevated temperature and pressure and for a sufficient time to further reduce the thickness of the thin-layer composite and to allow the isocyanate resin to interact with the wood fibers (FIG. 2(d)). As described above, it is believed that by heating the wood composite in the presence of the resin, the isocyanate of the resin forms a urethane linkage with the hydroxyl groups of the wood cellulose. Replacement of the hydroxyl groups of the cellulose with the urethane linkage prevents water from hydrating or being lost from the cellulose hydroxyl groups. Thus, once the resin has cured, a doorskin having a predetermined resistance to moisture is formed. As described above, in an embodiment, one of the dies may be coated with an anti-bonding agent. FIG. 2 shows an embodiment in which the female die 12 is coated on its inner surface with an antibonding agent 10.

In alternative embodiments, both dies (12 and 14) are coated with anti-bonding agent. For example, this embodiment may be preferred where both die surfaces do not have a grain pattern, but are smooth. Or, in an embodiment, both inner die surfaces may be coated with an anti-bonding agent, and the use of release agent to coat the mat may vary depending upon the particular wood composite being prepared. Or, in an embodiment, the method may employ release agent on the surface of the mat, without coating of the dies. In yet another embodiment, the method may employ an internal release agent in the mat, without coating of the dies.

Subsequently, the doorskin is allowed to cool (FIG. 2(e)) and then further processed (sizing and priming) prior to being applied to a doorframe.

Thus, the invention describes using a release agent and/or anti-bonding agent to prevent the thin-layer wood composite from sticking to the pressing dies during production.

The release agent and/or anti-bonding agent used to prevent the mat from sticking to the dies during production may be applied to the mat in various ways. Generally, when the mat is used to produce a standard doorskin, one of the dies comprises a recess and is described as the female die. Referring to FIG. 2, usually the female die 12 is positioned underneath the lower surface 18 of the mat, which is the surface of the mat that is adhered to the underlying doorframe (i.e., the inner surface). The other (upper) surface of the mat 16 corresponds to the side of the doorskin that will be on the outside of the door. Often, this side of the doorskin will include a grain texture to enhance the decorative effect. The die 14 used to press the upper side of the mat (i.e. the eventual outside of the door) may be termed the male die. Thus, the male die includes a protruding portion that is the mirror image of the recess on the female die, and optionally, a grain-like pattern on the surface of the die.

In one embodiment, an anti-bonding agent is coated onto the bottom (female) die. Depending on the actual anti-bonding agent used, the coating may be baked onto the bottom die. In this way, the coated die may be used several times before recoating with additional anti-bonding agent. For example, in an embodiment, the step of baking the anti-bonding agent onto the die surface comprises the steps of (i) cleaning the die surface substantially free of any dirt, dust or grease; (ii) spraying about 0.003 inches (3 mils; 0726 mm) of a 50% solution of the anti-bonding agent onto the die; and (iii) baking the die at over 300° F. (149° C.) for about 1-4 hours. In an embodiment, the step of cleaning the die comprises cleaning the die surface with a degreaser; wire brushing to remove solids; wiping the die surface with a solvent (such as acetone); and buffing with a cotton pad. The anti-bonding agent is then applied to provide a 3 mil thickness; and the dies heated to bake the coating onto the die. In some embodiments, the die may be coated with multiple layers of anti-bonding, with the baking step occurring after only the final coat or after only some, but not all of the coats.

Under suitable conditions, the anti-bonding agent that is baked onto the die (or dies) is stable enough with respect to the pressing conditions such that the die(s) can be used for over 2000 pressing cycles prior to requiring another coating with additional anti-bonding agent. Anti-bonding agents that are suitable for baking onto the die surface include Crystalcoat MP-3 13 and Silvue (SDC Coatings, Anaheim, Calif.), ISO-Strip-23 Release Coating (ICI Polyurethanes, West Deptford, N.J.), aminoethlyaminopropyltrimethoxysilane (Dow Corning Corporation), or the like.

Although a preferred method to facilitate removal of the doorskin from the die uses a die coated with anti-bonding agent, other equivalent methods to facilitate nonsticking of the wood composite to the die may be incorporated into the methods of the present invention. For example, to facilitate release of the doorskin, the die(s) may be nickel plated, covered with a ceramic layer, or coated with fluorocarbons.

As described above, a release agent may be sprayed onto one of the surfaces of the pre-pressed mat prior to the mat being pressed between the dies. For example, and referring again to FIG. 2, a release agent 8 may be sprayed onto the upper surface 16 of the mat 6 which is exposed to the male die 14. Preferably, the release agent 8 sprayed directly onto the surface of the mat is a release agent that is compatible with the wood and resin making up the composite. Preferably, the release agent sprayed on the wood comprises compounds such as PAT®-7299/D2, PAT®-1667 (Wurtz GmbH & Co., Germany), and the like.

The amount of release agent sprayed onto at least one side of the mat may range from 0.1 to 8.0 grams solids per square foot (1.1 to 86.1 grams per square meter) of mat. For example, the release agent may be sprayed onto the mat as a 25% aqueous solution. In an embodiment, the amount of release agent sprayed onto at least one side of the mat may comprise about 4 grams solids per square foot (i.e., 43.05 grams per square meter) of mat sprayed as a 25% aqueous solution.

The release agent used to coat the mat is distinct from the anti-bonding agent used to coat the die surface(s). The anti-bonding agent used to coat the die surface(s) generally can be one or more of silane, silicone, siloxane, fatty acids, and polycarboxyl compounds that are known to be effective coating agents. These anti-bonding agents, however, are not always suitable for spraying directly on the wood mat (or incorporating into the wood composite) since they may interfere with later finishing of the wood product by priming and/or painting.

As described herein, the present invention describes the use of isocyanate resins to prepare wood composites. One of the advantages of using isocyanate resins rather than formaldehyde crosslinked resins is that less energy is needed to dry the wood fiber prior to pressing the mat. As described herein, traditional phenol-formaldehyde resins are not compatible with wood having a water content much greater than 8%, as the water tends to interfere with the curing process. Also, excess moisture in the wood fiber can cause blistering when pressed with melamine-formaldehyde resins or urea-formaldehyde resins. Thus, for wood having a moisture content of greater than 8%, the wood must be dried for the curing step, and then re-hydrated later. In contrast, isocyanate-based resins are compatible with wood having a higher water content and thus, curing with isocyanate-based resins may obviate the need for the drying and the re-hydrating steps associated with formaldehyde-based resins. Moreover, the use of isocyanate resins in place of formaldehyde-based resins results in a reduction of formaldehyde resins. The present concentration of isocyanate resins results in lower volatile organic compound (VOC) emissions. Accordingly, the present composites provide synergistic environmental improvements over previous thin-layer lignocellulosic composites.

In an embodiment, the press time and temperature may vary depending upon the resin used. For example, using a toluene diisocyanate (TDI) resin as opposed to diphenylmethane diisocyanate (MDI) resin may shorten the press time by as much as 10%. Generally, when using isocyanate resins, very high temperatures are not required; thus, isocyanate resins are associated with decreased energy costs and less wear on the boiler or other energy generator. Still, composites made at very low temperatures do not display sufficient resistance to moisture to be commercially useful. Thus, the temperature used for pressing may range from 250° F. to 400° F. (121° C. to 204° C.), or more preferably, between 280° F. and 350° F. (138° C. to 177° C.). In an embodiment, ranges between 310° F. (154° C.) to about 330° F. (166° C.) are preferred.

The pressure used during pressing may be constant, or varied in a step-wise fashion. Depending upon the selected temperature and pressure conditions used for pressing, the total pressing may range from 30 seconds to 2 minutes or more. Thus, the pressure during the pressing step may include ranges from about 2500 psi (about 176 kg/cm²) to about 150 psi (about 10.5 kg/cm²). Or, the pressure may be applied in a step-wise manner. For example, the pressure during the pressing step may range from about 1200 psi (about 84.3 kg/cm²) for about 5 to 20 seconds followed by 500 psi (about 35.16 kg/cm²) for 10 to 80 seconds. In one embodiment, the pressure during the pressure step ranges from about 1200 psi (about 84.3 kg/cm²) for about 10 seconds to about 500 psi about 35.16 kg/cm²) for about 30 seconds.

Preferably, wood composites made by the method of the invention comprise significantly less linear expansion and swelling than wood composites made by conventional methods. Thus, doorskins made by the method of the present invention exhibit about 50% less linear expansion and thickness swelling than composite doorskins made with formaldehyde-based resins of the same content (such as, for example, 3% melamine-urea-formaldehyde doorskins) when boiled in water for 2 hours. Also, doorskins made by the present invention exhibit about 50% less linear expansion than non-isocyanate based doorskins when immersed in water for 24 hours at 70° F. (21.1° C.), a standard test used in the industry (ASTM D1037).

As described above, the thin-layer lignocellulosic composites of the present invention comprise a predetermined thickness, such that the resultant composite comprises a flat planar structure. In an embodiment, the predetermined thickness ranges from about 0.085 inches to about 0.250 inches (about 2.16 mm to about 6.35 mm). In an alternate embodiment, the predetermined thickness of the thin-layer composite may range from about 0.110 to about 0.130 inches (about 2.79 to about 3.30 mm).

Also in an embodiment, doorskins made by the methods of the present invention are significantly less dense than doorskins made using traditional formaldehyde-based resins. For a doorskin that is 0.12 inches (3.05 mm) thick and has 10% melamine-urea formaldehyde resin and 1.5% wax, the density is about 58 pounds per cubic foot (930 kg/m³). In contrast, doorskins of the present invention (3% MDI resin; 0.8% internal press release) may have a density as low as about 48 pounds per cubic foot (769.0 kg/m³).

### EXAMPLE

Various parameters that would be expected to improve the stability of doorskins exposed to moisture were tested, including altering the moisture content and other attributes of the wood fiber, altering the amount and type of the resin, and altering the press conditions (temperature, pressure and/or time).

Ultimately, it was found that isocyanate-based resin binders provided a wood composite that is resistant to water when resin levels of about 1% and up to about 5% were employed. When these levels of resin were used, however, the resulting composite tended to stick to the pressing dies during manufacture.

Various methods were tried to prevent the doorskins from sticking to the dies. It was determined that the addition of a release agent to the surface of the pre-pressed mat used to make the doorskin allowed the doorskin to be removed from the male die. In additional experiments, the release agent was added directly to the composite mixture. For effective release, approximately 0.1 to 4 wt % of the release agent was required. It was found that for consistent results, about 0.25 to 3% internal release agent was preferred.

As the release agent is theoretically only required at the surface, methods to treat the surface of the doorskin were evaluated. It was found that spraying the surface of the mat with a 25% solution of PAT®-7299/D2 (Wurtz GmbH & Co., Germany) provided sufficient release agent to successfully remove the doorskin from the male die. It was further found that concentrations of release agent ranging from 0.1 to 8 grams solid per square foot (1.1 to 86.1 grams per square meter) of mat were effective (generally administered as a 25% solution). About 2-4 grams release agent solids per square foot (2.2 to 43.05 grams per square meter) of mat were found to provide consistent results, with higher concentrations providing only minimally better results.

Methods were evaluated to apply a release agent to the underside of the mat and the top surface of the bottom die for each press load. It was found, however, that treating the surface of the bottom die with an anti-bonding agent may be preferable for eliminating bonding of the mat to the bottom die. An anti-bonding agent, such as Silvue (SDC Coatings) was used to coat the surface of the female die. Initial experiments used excess anti-bonding agent to flood the surface of the die. Further testing indicated that baking the anti-bonding agent onto the surface of the female (bottom) die allowed for the die to be used multiple times prior to being retreated. To bake the anti-bonding agent onto the die, the female die was treated by (i) cleaning the surface of the die substantially free of dust, dirt and grease using a degreaser, wire brush treatment and solvent; (ii) spraying about 0.003 inches (3 mils; 0.0762 mm) of a 50% solution of the release agent onto the die; and (iii) baking the die at a temperature of about 300° F. (149° C.) to 350° F. (177° C.) for about 1-4 hours.

Thus, it was found that addition of 2-4 g per square foot of a release agent to the upper surface of the pre-pressed mat, and baking the anti-bonding agent Silvue (SDC Coatings) onto the female (bottom) die allowed for easy removal of the doorskins having about 1% to about 5% MDI resin from both dies easily. Additionally, it was determined that over 2000 press loads could be made prior to recoating the female die with additional antibonding agent.

The wood composites made by the method of the invention demonstrated significantly less linear expansion and swelling than wood composites made by conventional methods. Thus, doorskins made by the method of the present invention exhibited 50% less linear expansion and thickness swelling than composite doorskins made with formaldehyde based resins of the same content (e.g., 1% melamine-urea-formaldehyde doorskins) when boiled in water for 2 hours. Also, doorskins made by the present invention exhibited 50% less linear expansion than comparable formaldehyde-based doorskins than non-isocyanate based doorskins when immersed in water for 24 hours at 70° F. (21.1° C.), a standard test used in the industry (ASTM D1037).

Also, doorskins made by the methods of the present invention were found to be significantly less dense than doorskins made using traditional formaldehyde-based resins.

Accordingly, the present methods form composites that have increased resistance to moisture-induced shrinking and/or swelling as compared to composites with similar concentrations of non-isocyanate resins. The present methods also may be used to form composites having comparable resistance to moisture-induced shrinking and/or swelling as composites having greater concentrations of isocyanate resins. The inventors, therefore, have developed methods and products demonstrating reduced emissions, while maintaining and improving the physical characteristics of the composites using concentrations previously understood to be unworkable.

The present methods also result in reduced energy costs, high-throughput production, and reduced over-all costs while maintaining the necessary moisture resistance of the composites.

It will be understood that each of the elements described above, or two or more together, may also find utility in applications differing from the types described. Although the invention has been illustrated and described as a method for high-throughput preparation of thin-layer lignocellulosic composites, such as doorskins, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as described herein.

That which is claimed is:

1. A method of producing a thin-layer lignocellulosic composite having increased resistance to moisture-induced shrinking or swelling comprising:
(a) forming a lignocellulosic composite mixture comprising at least one type of lignocellulosic fiber comprising a predetermined moisture content of at least about 4%, at least about 1 wt % of an organic isocyanate resin, at least about 0.1 wt % tackifier, and at least about 0.1% release agent, wherein the mixture is substantially free of added wax;
(b) pre-pressing the mixture into a loose formed mat; and
(c) pressing the mat between two dies at an elevated temperature and pressure and for a sufficient time further reducing the thickness of the mat to form a thin-layer composite of predetermined thickness, and allowing the isocyanate resin to interact with the lignocellulosic fiber such that the resultant thin-layer composite has a predetermined resistance to moisture.

2. The method according to claim 1, wherein the lignocellulosic fiber comprises wood.

3. The method according to claim 1, wherein the tackifier is present in an amount of between about 0.1% and about 5 wt % of the mixture.

4. The method according to claim 3, wherein the tackifier is selected from the group consisting of rosins, lignins, hydrocarbons, hydrogenated hydrocarbons, pure monomers, hydrogenated pure monomers, water-based dispersions, and combinations thereof.

5. The method according to claim 1, further comprising spraying additional release agent onto the loose-formed mat before the pressing step.

6. The method according to claim 5, wherein the release agent comprises an emulsion of surfactants and polymers.

7. The method according to claim 5, wherein the release agent is added to the mixture prior to pre-pressing the mixture into a loose formed mat.

8. The method according to claim 7, wherein the amount of release agent added to the mixture ranges from about 0.1% to about 4 wt %.

9. The method according to claim 1, wherein the release agent will not substantially interfere with subsequent processing of the composite.

10. The method according to claim 9, wherein the amount of release agent sprayed onto the mat surface comprises from about 0.1 to about 8.0 grams solids per square foot (about 1.1 to about 86.1 grams per square meter) of mat surface.

11. The method according to claim 1, further comprising exposing at least one surface of at least one die to an anti-bonding agent.

12. The method according to claim 11, wherein the step of exposing the at least one surface of the at least one die to the anti-bonding agent comprises coating the at least one surface of the at least one die with the anti-bonding agent.

13. The method according to claim 11, wherein the anti-bonding agent is selected from the group consisting of silane, silicone, siloxane, fatty acids, polycarboxyl compounds, and combinations thereof.

14. The method according to claim 1, wherein the lignocellulosic mixture comprises about 80% to about 98 wt % fiber.

15. The method according to claim 1, wherein the predetermined moisture content of the lignocellulosic fiber comprises a range from about 5% to about 15% moisture content by weight after drying.

16. The method according to claim 1, wherein the isocyanate comprises diphenylmethane diisocyanate (MDI) or toluene diisocyanate (TDI).

17. The method according to claim 16, wherein the isocyanate comprises diphenylmethane-4,4′-diisocyanate.

18. The method according to claim 1, wherein the mixture comprises from about 1% to about 5 wt % resin solids.

19. The method according to claim 1, wherein the mixture comprises about 2.5 wt % resin solids.

20. The method according to claim 1 wherein the temperature used to press the mat into the thin layer composite comprises a range from about 250° F. (about 121° C.) to about 400° F. (about 204° C.).

21. The method according to claim 1, wherein the temperature used to press the mat into the thin layer composite comprises a range from about 280° F. (about 138° C.) to about 350° F. (about 177° C.).

22. The method according to claim 1, wherein the pressure used to press the mat into the thin layer composite comprises a range from about 2500 psi (about 176 kg/cm²) to about 150 psi (10.5 kg/cm²).

23. The method according to claim 1, wherein the thin-layer composite comprises up to 25% less linear expansion and thickness swelling after being immersed for 24 hours in 70° F. (21° C.) water than a thin-layer composite comprising a non-isocyanate based resin, such as urea formaldehyde.

24. The method according to claim 1, wherein the predetermined resistance to moisture comprises a thickness swelling of less than 15% after being immersed for 24 hours in water at 70° F. (21° C.).

25. A thin-layer wood composite made by the method of claim 1.

26. A thin-layer lignocellulosic composite comprising a mixture of no more than about 99 wt % of at least one type of lignocellulosic fiber, wherein the fiber comprises a predetermined moisture content of at least about 4%, at least about 1 wt % of an organic isocyanate resin, a release agent, and a tackifier, wherein the mixture is substantially free of added wax and wherein the mixture is pressed between two dies at an elevated temperature and pressure and for a sufficient time forming a thin-layer composite of predetermined thickness, and allowing the isocyanate resin to interact with the lignocellulosic fiber such that the resultant thin-layer composite has a predetermined resistance to moisture.

27. The thin-layer lignocellulosic composite according to claim 26, wherein the lignocellulosic fiber comprises wood.

28. The thin-layer lignocellulosic composite according to claim 26, wherein the mixture comprises between about 0.1% and about 5 wt % tackifier.

29. The thin-layer lignocellulosic composite according to claim 26, wherein the tackifier is selected from the group consisting of rosins, lignins, hydrogenated rosins, hydrocarbons, hydrogenated hydrocarbons, pure monomers, hydrogenated pure monomers, water-based dispersions, and combinations thereof.

30. The thin-layer lignocellulosic composite according to claim 26, wherein the release agent comprises an emulsion of surfactants and polymers.

31. The thin-layer lignocellulosic composite according to claim 26, wherein the release agent is added to the wood mixture prior to pre-pressing the mixture into a loose formed mat.

32. The thin-layer lignocellulosic composite according to claim 31, wherein the amount of release agent added to the composite ranges from about 0.1% to about 4 wt %.

33. The thin-layer lignocellulosic composite according to claim 26, wherein the mixture is preformed into a loose formed mat, and additional release agent is sprayed onto at least one surface of the mat prior to pressing the mat into the thin layer composite.

34. The thin-layer lignocellulosic composite according to claim 33, wherein the amount of release agent sprayed on to the mat surface comprises about 0.1 to about 8.0 grams solids per square foot (about 1.1 to about 86.1 grams per square meter) of the surface.

35. The thin-layer lignocellulosic composite according to claim 26, wherein the lignocellulosic fiber ranges from about 80% to about 98 wt %.

36. The thin-layer lignocellulosic composite according to claim 26, wherein the predetermined moisture content of the fiber ranges from about 4% to about 15% moisture by weight after drying.

37. The thin-layer lignocellulosic composite according to claim 26, wherein the isocyanate comprises diphenylmethane diisocyanate or toluene diisocyanate.

38. The thin-layer lignocellulosic composite according to claim 26, wherein the isocyanate comprises diphenylmethane-4,4′-diisocyanate.

39. The thin-layer lignocellulosic composite according to claim 26, wherein the mixture comprises from about 1% to about 5 wt % resin solids.

40. The thin-layer lignocellulosic composite according to claim 26, wherein the predetermined resistance to moisture comprises up to a 25% reduction in linear expansion and thickness swelling after being immersed for 24 hours in 70° F. (21° C.) water than a thin-layer composite comprising a resin that does not include isocyanate, such as urea formaldehyde.

41. The thin-layer lignocellulosic composite according to claim 26, wherein said predetermined resistance to moisture comprises a thickness swelling of less than 15% after being immersed for 24 hours in water at 70° F. (21° C.).

42. The thin-layer lignocellulosic composite according to claim 26, wherein the predetermined thickness ranges from about 0.085 inches (about 2.16 mm) to about 0.250 inches (about 6.35 mm).

43. The thin-layer lignocellulosic composite according to claim 26, wherein the predetermined thickness ranges from about 0.110 inches (about 2.79 mm) to about 0.130 inches (about 3.30 mm).

44. The thin-layer lignocellulosic composite according to claim 42, further comprising a density of less than about 65 pounds per cubic foot (about 1042 kg/m³).

45. The thin-layer lignocellulosic composite according to claim 42, further comprising a density of less than about 55 pounds per cubic foot (about 881.2 kg/m³).

46. The thin-layer lignocellulosic composite according to claim 42, further comprising a density of between about 48 pounds per cubic foot (about 769.0 kg/m³) and about 62 pounds per cubic foot (about 993.4 kg/m³).
